(19) United States
(12) Patent Application Publication
(10) Pub. No.: US 2005/0188053 A1
(43) Pub. Date: Aug. 25, 2005

(54) Apparatus and method for inspecting electronic announcement

(76) Inventors: Atsushi Shimamura, Yokohama (JP); Toshiyuki Moritsu, Kawasaki (JP); Kunihito Takeuchi, Zushi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/996,442

(22) Filed: Nov. 26, 2004

(30) Foreign Application Priority Data
Nov. 25, 2003 (JP) 2003-393832

(51) Int. Cl. G06F 15/16

(52) U.S. Cl. 709/217

(57) ABSTRACT

An apparatus includes: an inspection receiving module which receives an inspection request for announcement data from an information registration terminal; an inspection processing module which requests an information disclosure server for announcement data and stores the acquisition result of the requested announcement data in a storage module; an alert sending module which sends an alert message to the information registration terminal when the requested announcement data has failed to be acquired; a certification issuing module which creates a certificate described with acquisition information of announcement data; and a storage module which stores inspection target information and a announcement archive.

### BACKGROUND

The present invention relates to a technology for inspecting announcements, particularly to a technology for inspecting electronic announcements.

A announcement system has been utilized as information disclosure means by which an incorporated company widely announces matters relating to management of that entity to shareholders, parties of interest and others. For example, incorporated companies make a variety of announcements such as announcement for notifying issuance of new shares and division of shares, announcement for accepting objections, and announcement for announcing financial closing. These announcements are made by being published on official gazettes or on daily newspapers as defined by articles of incorporation.

In addition, other than announcements on official gazettes and daily newspapers, electronic announcement is considered which utilizes networks such as the Internet that becomes rapidly wide spread. The electronic announcement refers to electronic data published on networks.

Japanese Patent Laid-open Announcement No. 2000-76264 describes an Internet information retrieval system that retrieves information disclosed on the Internet. Furthermore, there are Websites that can retrieve histories of various information disclosed on the Internet (for example, http://www.archive.org). Moreover, U.S. 2001/002472 (Japanese Patent Laid-open Announcement No. 2001-154989) describes a technique which certifies that given information has been disclosed on networks.

In the meantime, the current announcement system defines announcement to be published only on official gazettes and daily newspapers, because the fact that announcement has been made is easily certified. More specifically, when announcement is made on official gazettes or daily newspapers, the contents of this announcement are published on official gazettes or daily newspapers, which are paper media, and are distributed to various places massively. Then, it is extremely difficult to modify and cancel the contents of the announcement published on paper, once distributed.

On the contrary, when electronic announcement is made with the use of networks, it is extremely difficult to certify that the electronic data of announcement has been continuously disclosed on networks (the fact that announcement has been made). That is, even when an access to the electronic data of announcement existing on the networks is once made possible, an access is not necessarily made possible to the electronic data of the announcement continuously afterward. Further, when access to the electronic data of the announcement was not possible, it is required to inform the persons (or devices) who provide the electronic announcement in order to promptly recover accessibility. However, traditional technology does not consider certification of the fact that continued disclosure of the electronic data of the announcement was made on the Internet.

### SUMMARY

An object of the present invention is to provide an inspection technique which certifies that electronic data being a target for announcement is being continuously disclosed on the Internet.

In the present invention, an acquisition request for the electronic data of announcement is repeatedly performed, and it is inspected after a announcement period has elapsed whether the electronic data of announcement has been continuously disclosed based on the acquisition result of the electronic data of announcement repeatedly performed.

For example, an inspection apparatus for inspecting announcement data disclosed through a network, which includes:
a storage module which stores inspection target information including address information and a announcement expiration due of announcement data, and acquired inspection information including an acquisition result and an acquisition date and time of each of the announcement data;
a receiving module which receives the inspection target information of the announcement data from an external system, and stores the target information in the storage module;
an inspecting module which reads out inspection target information stored in the storage module at predetermined time intervals assigned for each announcement data, requests announcement data through a network based on the inspection target information read out, and stores the acquired inspection information of the pertinent requested announcement data in the storage module at every request for announcement data;
an alert module which sends an alert message to the external system when announcement data requested by the inspecting module has failed to be acquired; and
an issuing module which refers to the announcement expiration due of the inspection target information stored in the storage module, reads from the storage module the acquired inspection information of the announcement data expired the announcement due, and creates a certificate including the acquisition result and the acquisition date and time at every request for the pertinent announcement data.

According to the present invention, it can be certified that the electronic data being the target for announcement disclosed on the networks has been continuously disclosed during the obliged announcement period.

### BRIEF DESCRIPTION OF THE DRAWINGS

FIG. 1 is a schematic diagram illustrating a announcement inspection system to which an embodiment according to the invention is applied;

FIG. 2 is a diagram illustrating an exemplary hardware configuration of an information registration terminal, an information disclosure server, an inspection device, and a user terminal;

FIG. 3 is a process flow diagram illustrating the announcement inspection system;

FIG. 4 is a diagram illustrating an exemplary data structure of the inspection target information;

FIG. 5 is a diagram illustrating an exemplary data structure of a announcement archive;

FIG. 6 is a process flow diagram illustrating an inspection process;

FIG. 7 is a diagram illustrating an exemplary screen of an input form of a first additional function; and

FIG. 8 is a schematic diagram illustrating a system when inspection information is created from operation information from the user terminal, which is a second additional function.

### DETAILED DESCRIPTION OF THE PREFERRED EMBODIMENTS

This embodiment is a announcement inspection system which discloses announcement done by incorporated companies as electronic data on networks and inspects that the electronic data of this announcement has been publicly disclosed (published) properly. In addition, in the embodiment, announcement done by an incorporated company (hereinafter, it is referred to as a ‘company’) is a target, but the target is not limited thereto. For example, it is acceptable that a company is corporations or other organizations. Furthermore, the target for inspection may be other information, not limited to the electronic data of announcement.

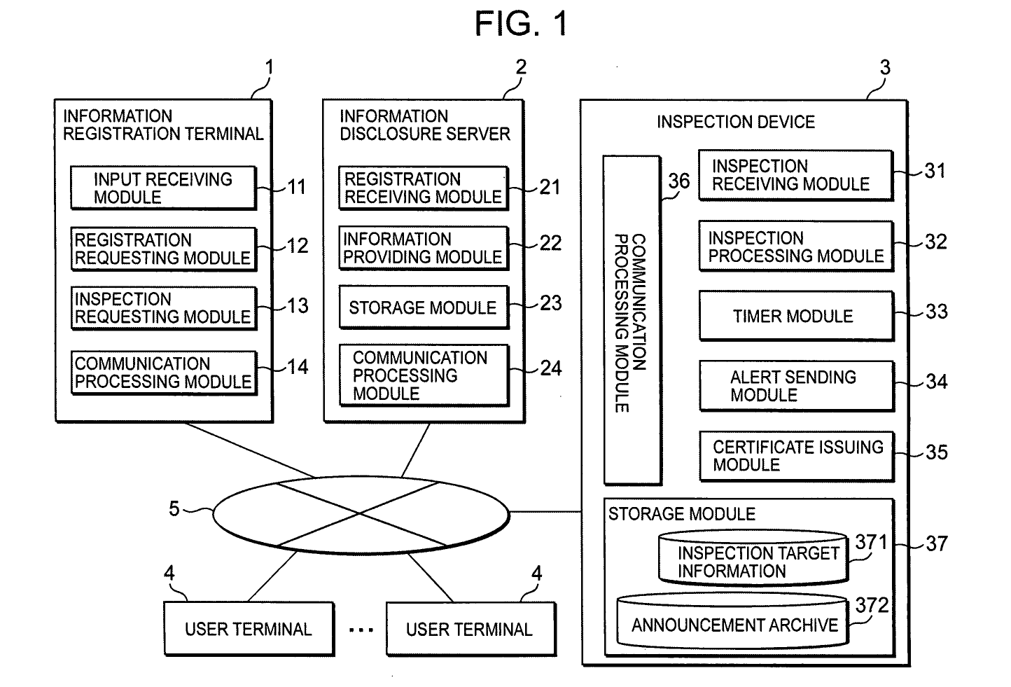

FIG. 1 is a schematic diagram illustrating a announcement inspection system to which an embodiment according to the present invention is applied. As shown in the drawing, the announcement inspection system of the embodiment has an information registration terminal 1, an information disclosure server 2, an inspection device 3, and at least one user terminal 4, all of which are connected to a network 5 such as the Internet.

The information registration terminal 1 is an information processing device that sends announcement information for making electronic announcement to the information disclosure server 2 and sends inspection request information for requesting inspection of electronic announcement to the inspection device 3. The information registration terminal 1 has an input receiving module 11 which receives various information inputted from an input control unit, a registration requesting module 12 which requests the information disclosure server 2 for registration of announcement information, an inspection requesting module 13 which requests the inspection device 3 for inspection, and a communication processing module 14 which sends and receives data with the other devices through the network 5. Moreover, the information registration terminal 1 is generally installed at a place where a system administrator inside a company making announcement (to which the administrator belongs) can operate. However, when a third party such as an official organization registers announcement information in the information disclosure server 2, the information registration terminal 1 could be installed at a place outside the company making announcement.

The information disclosure server 2 is an information processing device that registers the announcement information sent from the information registration terminal 1 and provides announcement information to the user terminal 4 in response to requests from the individual user terminals 4. The information disclosure server 2 has a registration receiving module 21 which receives announcement information from the information registration terminal 1, an information providing module 22 which provides announcement information to the user terminal 4, a storage module 23 which stores announcement information, and a communication processing module 24 which sends and receives data with the other devices through networks. Furthermore, the information disclosure server 2 is generally managed by a company (an owner company) making announcement and is installed in the owner company. However, it is acceptable to manage the server by companies other than the owner company such as Internet service providers or official organizations. When the information disclosure server 2 is managed by Internet service providers or official organizations, the information disclosure server performs electronic announcements for multiple companies.

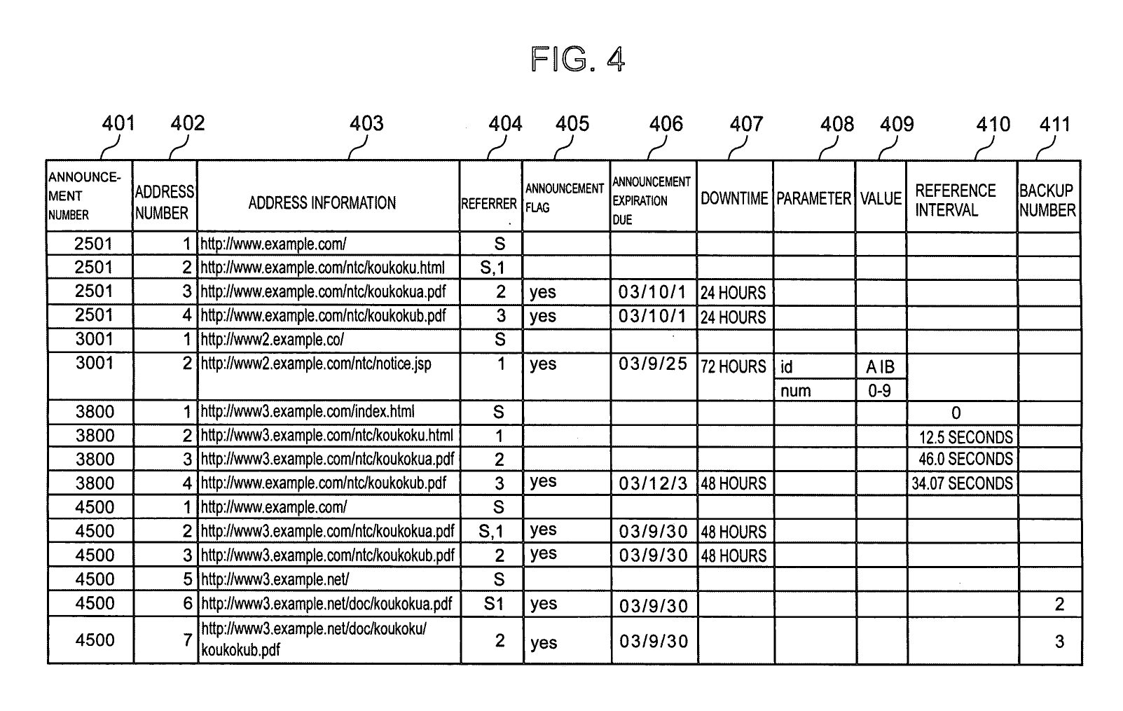

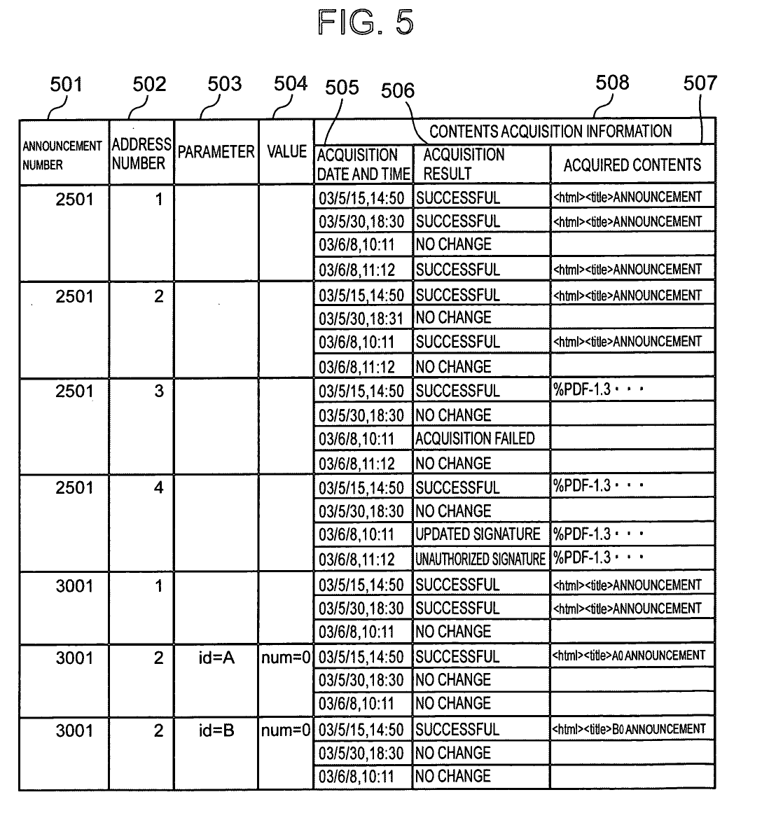

The inspection device 3 is an information processing device that inspects whether the information disclosure server 2 is continuously disclosing announcement information during the announcement period and creates a certificate having the inspection result described thereon. The inspection device 3 has an inspection receiving module 31 which receives inspection request information from the information registration terminal 1, an inspection processing module 32 which inspects announcement information, a timer module 33 which provides time information to the inspection processing module 32, an alert sending module 34 which sends abnormality detected by the inspection processing module 32 to the information registration terminal 1, a certificate issuing module 35 which issues a certificate having the description of the inspection result done by the inspection processing module 32 after the announcement period, a communication processing module 36 which sends and receives data with the other devices through networks, and a storage module 37 which stores inspection target information 371 and a announcement archive 372 therein. Moreover, the inspection target information 371 and the announcement archive 372 will be described later in FIGS. 4 and 5. In addition, announcement information is to be inspected by a third party (for example, an official organization) other than the company having made announcement. Therefore, the inspection device is considered to be installed in the organization of a third party.

The user terminal 4 is an information processing device that requests announcement information disclosed by the information disclosure server 2. Users of the user terminal 4 such as shareholders and creditors use a Web browser to acquire (download) announcement information disclosed on the information disclosure server 2 for displaying it on an output control unit of the user terminal 4. Furthermore, the Web browser is application software that browses (acquires) information disclosed on the Internet.

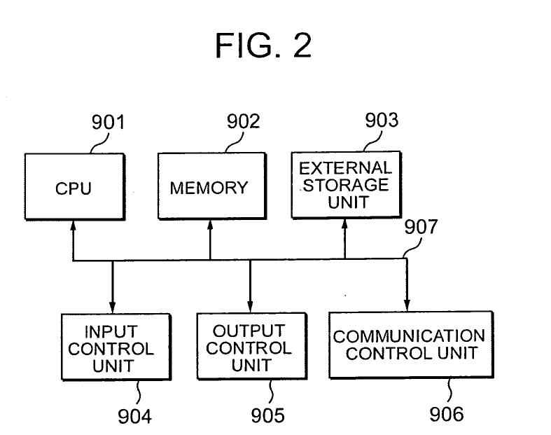

The information registration terminal 1, the information disclosure server 2, the inspection device 3, and the user terminal 4 described above can all use a general computer system as shown in FIG. 2, for example, having a CPU (or MPU) 901, a memory 902, an external storage unit 903 such as HDD, an input control unit 904 such as a keyboard and a mouse, an output control unit 905 such as a display and a printer, a communication control unit 906 for connecting to networks, and a bus 907 that connects the individual devices. In this computer system, the CPU 901 executes given programs loaded on the memory 902, and thus the individual functions of each device are implemented.

For example, the individual functions of the information registration terminal 1, the information disclosure server 2, the inspection device 3, and the user terminal 4 are implemented by the CPUs 901: programs for the information registration terminal 1 by the CPU 901 of the information registration terminal 1, programs for the information disclosure server 2 by the CPU 901 of the information disclosure server 2, programs for the inspection device 3 by the CPU 901 of the inspection device 3, and programs for the user terminal 4 by the CPU 901 of the user terminal 4. In this case, the memory 902 or the external storage unit 903 of the information disclosure server 2 is used for the storage module 23 of the information disclosure server 2. Moreover, the memory 902 or the external storage unit 903 of the inspection device 3 is used for the storage module 37 of the inspection device 3.

In addition, a WWW (World Wide Web) server, for example, can be used for the information disclosure server 2. Besides, Web clients can be used for the information registration terminal 1, the inspection device 3, and the user terminal 4.

Next, a process flow of the announcement inspection system of the embodiment will be described.

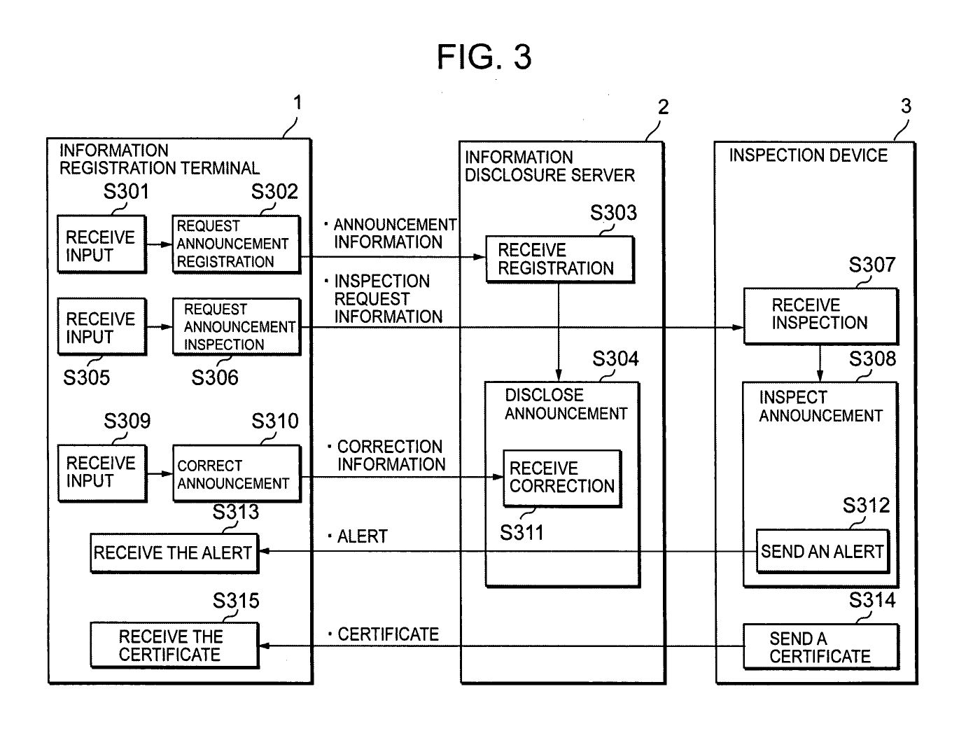

FIG. 3 shows a process flow of the announcement inspection system. Here, the process described below is about an inspection process for a single item of announcement information, but the same process is carried out for every item of announcement information even when multiple items of announcement information are inspected at the same time.

First, the input receiving module 11 of the information registration terminal 1 receives input of announcement information from the input control unit 904 such as a keyboard (S301). The announcement information includes announcement contents that are electronic data showing the contents of announcement to be disclosed on networks, referrer contents that refer to announcement contents, storage location information about announcement contents and referrer contents, and a announcement expiration due of announcement contents. The announcement contents and the referrer contents are Web contents such as HTML (Hyper Text markup Language) files, document files, and image files that can be sent through networks. Furthermore, these contents could be a data that creates contents, such as processing programs (scripts) for creating HTML files. Moreover, referrer contents might not be inputted from the input control unit 904 when they are stored in the storage module 23 of the information disclosure server 2 beforehand.

The storage location information indicates storage locations (directories and file names) of the individual contents. The announcement expiration due indicates the end (day, month and year) of the announcement period predetermined at every type of announcement. Then, the registration requesting module 12 of the information registration terminal 1 uses the communication processing module 14, and sends (uploads) the announcement information received by the input receiving module 11 to the information disclosure server 2 (S302).

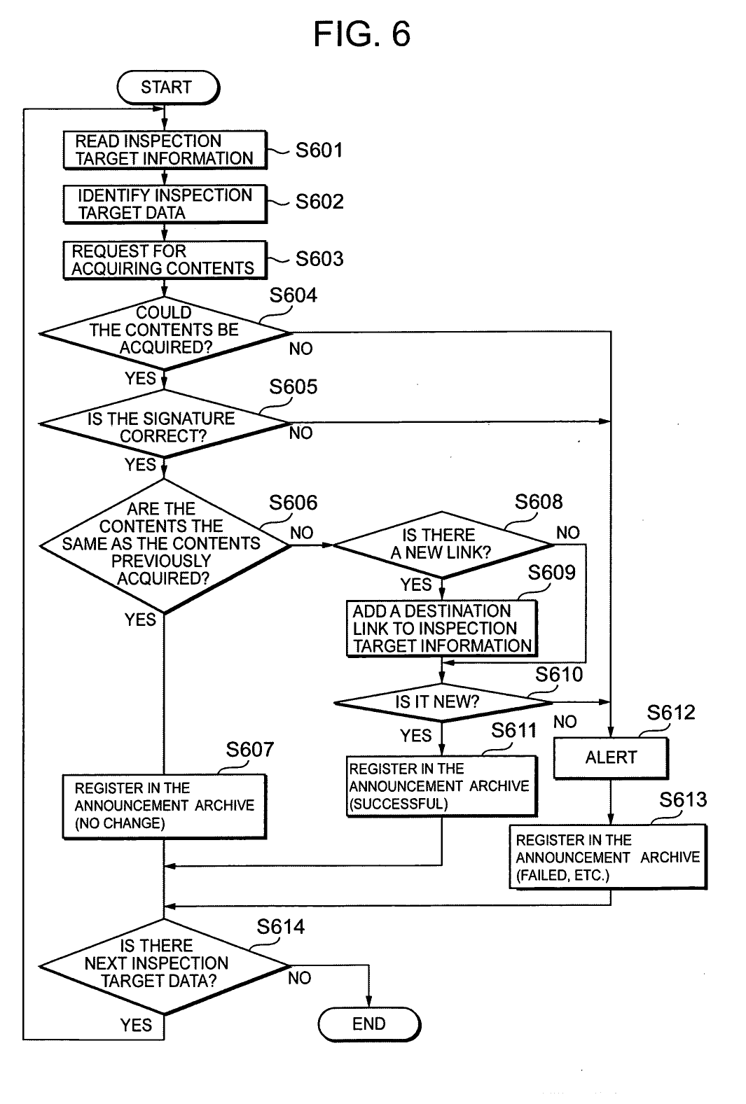

Subsequently, the registration receiving module 21 of the information disclosure server 2 uses the communication processing module 24 to receive announcement information from the information registration terminal 1, and stores the announcement contents and the referrer contents at the storage locations in the storage module 23 specified by storage location information (S303). Then, the information providing module 22 of the information disclosure server 2 discloses the announcement contents and the referrer contents stored in the storage module 23 until the announcement expiration due. More specifically, the server receives a request from the user terminal 4 or the inspection device 3, and sends the contents to the user terminal 4 or the inspection device 3 (S304). Furthermore, the user terminal 4 uses a Web browser, for example, to acquire the contents. More specifically, the user terminal 4 sends a message that requests the information disclosure server 2 for the contents, and the information disclosure server 2 sends the requested contents to the user terminal 4. Subsequently, the user terminal 4 displays the contents sent on the output control unit 905. Moreover, a method by which the inspection device 3 acquires (inspects) the contents will be described later in FIG. 6.

Besides, the input receiving module 11 of the information registration terminal 1 receives information identifying the inspection target inputted from the input control unit 904 and inspection request information required for inspection such as the announcement expiration due (S305) In addition, the detail of inspection request information will be described later in the inspection target information 371 to be described with reference to FIG. 4. Subsequently, the inspection requesting module 13 of the information registration terminal 1 uses the communication processing module 14 to send inspection request information to the inspection device 3 (S306). Then, the inspection receiving module 31 of the inspection device 3 uses the communication processing module 36 to receive inspection request information from the information registration terminal 1, and stores it in the storage module 37 (S307).

After that, the inspection processing module 32 of the inspection device 3 performs the inspection process for the inspection target requested by the information registration terminal 1 (S308). More specifically, the inspection processing module 32 repeatedly makes access to the information disclosure server 2 and acquires the announcement contents and the referrer contents until the announcement expiration due included in inspection request information.

Furthermore, the information registration terminal 1 sometimes corrects the announcement contents or the referrer contents disclosed by the information disclosure server 2 (for example, in the cases where items have been entered mistakenly or an electronic signature has been modified, which will be described later). When contents are to be corrected, the input receiving module 11 of the information registration terminal 1 receives the corrected contents and storage location information for the corrected contents from the input control unit 904 (S309). Then, the registration requesting module 12 uses the communication processing module 14 to send the corrected contents and the storage location information to the information disclosure server 2 (S310). Here, the storage location information of the corrected contents is the same as the storage location information of the announcement information sent at the time of registration request for the pertinent contents was made (S302). Subsequently, the registration receiving module 21 of the information disclosure server 2 uses the communication processing module 24 to receive the corrected contents and the storage location information, and stores the corrected contents at the storage location in the storage module 23 specified by the storage location information (S311).

Besides, the inspection processing module 32 of the inspection device 3 sometimes detects abnormality when the contents have not been acquired from the information disclosure server 2 or when the announcement contents have been modified. When the inspection processing module 32 detects abnormality, it notifies the alert sending module 34 that abnormality has been detected. The alert sending module 34 uses the communication processing module 36 to send an alert (a message that calls attention or gives warning) to the information registration terminal 1 (S312). Then, the communication processing module 14 of the information registration terminal 1 receives the alert, and notifies an administrator of the information registration terminal 1 that abnormality is being generated in the information disclosure server 2 by outputting the data of the alert to the output control unit 905 (S313).

Then, after the announcement expiration due has elapsed, the certificate issuing module 35 of the inspection device 3 creates a certificate describing acquisition conditions of the announcement contents (that is, the inspection result), and uses the communication processing module 36 to send it to the information registration terminal 1 (S314). This certificate is a written statement that certifies to third parties that the electronic announcement has been duly made on networks. Subsequently, the communication processing module 14 of the information registration terminal 1 receives the certificate sent from the inspection device 3 (S315).

In addition, the information registration terminal sometimes notifies or files other organizations (official organizations such as offices) that electronic announcement has been made after the announcement period is finished. The systems of the other organizations then perform given operations (such as registration) based on notifying (filing) the fact that the electronic announcement has been made. In this case, not shown in the drawing, the information registration terminal 1 receives an instruction inputted from the input control unit 904, sends the certificate received from the inspection device 3 to the systems of the other organizations, and requests for processing based on the electronic announcement. Furthermore, the information registration terminal 1 can receive an instruction inputted from the input control unit 904, and can request the inspection device 3 to send the certificate to the other organizations instructed. Subsequently, the inspection device 3 receives the request from the information registration terminal 1, and sends the certificate directly to the systems of the other organizations.

Next, the inspection target information 371 stored in the storage module 37 of the inspection device 3 will be described.

FIG. 4 is an exemplary table configuration of the inspection target information 371. As shown in the drawing, the inspection target information 371 has a announcement number 401, an address number 402, address information 403, a referrer 404, a announcement flag 405, a announcement expiration due 406, downtime 407, a parameter 408, a value 409, a reference interval 410, and a backup number 411. The inspection target information 371 is a database that stores inspection target data making these items of information one set therein. Here, the announcement number 401, the address number 402, and the address information 403 are information for specifying inspection targets, and the other information is information that indicates inspection methods.

Furthermore, the inspection target information 371 not only includes inspection target data of the announcement contents but also inspection target data of the referrer contents. In order to inspect (acquire) announcement contents disclosed on the information disclosure server 2, an access is sometimes made to the pertinent announcement contents by following links to contents other than the pertinent announcement contents. Therefore, contents including referrer contents that are likely to be referred for acquiring the pertinent announcement contents are also registered in the inspection target information 371, other than announcement contents.

The announcement number 401 is a unique identification number that identifies announcement information. When receiving an inspection request from the information registration terminal 1, the inspection receiving module 31 of the inspection device 3 acquires (assigns) an unused announcement number 401 and stores it in the announcement number 401. More specifically, a single announcement number 401 is assigned at every time when the information registration terminal 1 makes an inspection request for announcement information.

The address number 402 is a number that uniquely identifies inspection target data included in a single announcement number 401. As similar to the announcement number 401, when the inspection receiving module 31 receives an inspection request for announcement information from the information registration terminal 1, the inspection receiving module 31 of the inspection device 3 assigns a number. In addition, in the example of the address number 402 shown in FIG. 4, numbers are assigned sequentially starting from ‘1’. The address information 403 is identification information that indicates the storage location (destination) of contents on networks. For example, URL (Uniform Resource Locator) and URI (Uniform Resource Identifier) are used. In the embodiment, URL is used. The address information 403 is included in inspection request information sent by the information registration terminal 1 to the inspection device 3. Furthermore, it is acceptable that the address information 403 of another server is set to the address information 403 in the inspection target information 371 other than the information disclosure server 2. This is because an access is sometimes made to the announcement contents disclosed on the information disclosure server 2 by following the referrer contents (contents having links to the announcement contents) disclosed on another server.

The referrer 404 is information that indicates which contents of inspection target data link to the contents of pertinent inspection target data. More specifically, the address number 402 of the contents to be a link source is set to the referrer 404. However, when there is no address number 402 to be a link source, ‘S (Start)’ is set. When ‘S’ is set to the referrer 404, these cases can be considered: the case where contents not included in the inspection target information 371 link thereto; the case where a URL is directly inputted into the Web browser of the user terminal 4; and the case where a bookmarking function (function that stores the address information (URL)) is used. The referrer 404 is included in inspection request information sent by the information registration terminal 1 to the inspection device 3.

The inspection processing module 32 of the inspection device 3 refers to the referrer 404, and determines the order of acquiring (making access to) contents. The order of acquiring contents will be described, taking inspection target data ‘2501’ in the announcement number 401 shown in FIG. 4 as an example. To begin with, the inspection processing module 32 first makes access to the contents with ‘S’ for the referrer 404 (the address number 402 is 1), and then makes access to the contents with ‘1’ for the referrer 404 (the address number 402 is 2). Subsequently, the inspection processing module 32 makes access to the contents with ‘2’ for the referrer 404 (the address number 402 is 3), and lastly makes access to the contents with ‘3’ for the referrer 404 (the address number 402 is 4). Moreover, there are two ways to make access to the contents with ‘S, 1’ for the referrer 404 (the address number is 2): an access is made through a link from the contents with ‘1’ for the address number 402; and an access is made at first time.

The announcement flag 405 is a flag that identifies whether the contents of the pertinent inspection target data is announcement contents. When the contents are announcement contents, ‘yes’ is stored, whereas the contents are referrer contents that are referred to acquire announcement contents, the column is spaced (blank). Here, the announcement contents are contents that show data of the electronic announcement. The announcement flag 405 is included in inspection request information sent by the information registration terminal 1 to the inspection device 3.

When the contents of the pertinent inspection target data are announcement contents (the announcement flag 405 is ‘yes’), the expiration timing of the announcement period for the announcement contents is stored in the announcement expiration due 406. Hence, it is a timing for the inspection processing module 32 of the inspection device 3 to end inspection of the announcement contents. The announcement expiration due 406 is included in inspection request information sent by the information registration terminal 1 to the inspection device 3.

When the contents of the pertinent inspection target data are announcement contents (the announcement flag 405 is ‘yes’), the maximum allowable suspension time is stored in the downtime 407. The suspension time is a period of time that announcement contents cannot be acquired because of failure of the information disclosure server 2 or the other factors. In addition, the suspension time also includes a period of time that announcement contents with invalid data have been disclosed. The downtime 407 is predefined for every type of announcement by 10% of the total announcement period, for example. Then, the downtime 407 is included in inspection request information sent by the information registration terminal 1 to the inspection device 3.

In the parameter 408 and the value 409, a parameter 408 that is inputted from the input control unit 904 of the user terminal 4 and a value 409 that the parameter 408 can take are stored when the contents of the pertinent inspection target data are acquired. The parameter 408 and the value 409 are included in inspection request information sent by the information registration terminal 1 to the inspection device 3. The parameter 408 and the value 409 will be described in a first additional function of the announcement inspection system, which will be described later.

The reference interval 410 stores the timing of acquiring the contents of the pertinent inspection target data therein. In inspection target data ‘3800’ in the announcement number 401 shown in FIG. 4, ‘0’ is stored in the reference time 410 for address number 1, ‘12.5 seconds’ is stored in the reference time 410 for address number ‘2’, ‘46.0 seconds’ is stored in the reference time 410 for address number ‘3’, and ‘34.07 seconds’ is stored in the reference time 410 for address number ‘4’. This shows that after 12.5 second from a request for the contents with ‘1’ for the address number 402, the contents with ‘2’ for the address number 402 are requested. Furthermore, this also shows that after 46.0 seconds from a request for the contents with ‘1’ for the address number 402, the contents with ‘3’ for the address number 402 are requested. Here, a method for setting the reference interval 410 will be described in a second additional function of the announcement inspection system, which will be described later.

The backup number 411 stores the address number 402 of the contents disclosed on the information disclosure server 2 therein, when the contents of the pertinent inspection target data is disclosed on a backup server other than the information disclosure server 2. In FIG. 4, ‘2’ is set in the backup number 411 for the contents with ‘4500’ for the announcement number 401 and ‘6’ for the address number 402. This shows that the contents with ‘6’ for the address number 402 are being disclosed on the backup server as the backup for the contents with ‘2’ for the address number 402. The backup number is included in inspection request information sent by the information registration terminal 1 to the inspection device 3. Here, the backup number 411 will be described in a fourth additional function of the announcement inspection system, which will be described later.

Next, the announcement archive 372 stored in the storage module 37 of the storage module in the inspection device 3 will be described.

FIG. 5 shows an exemplary table configuration of the announcement archive 372. The announcement archive 327 is a database that stores the result of an inspection process performed by the inspection processing module 32. As shown in the drawing, the announcement archive 372 has a announcement number 501, an address number 502, a parameter 503, and a value 504. Also, the announcement archive 372 has at least one item of content acquisition information 508 including acquisition date and time 505, an acquisition result 506, and an acquired content 507 of the contents identified by the information. Here, the content acquisition information 508 is created by the number of times that contents have been acquired.

The announcement number 501, the address number 502, the parameter 503, and the value 504 are the same as the announcement number 401, the address number 402, the parameter 408, and the value 409 described in the inspection target information 371 (see FIG. 4). These items of information specify the contents of an inspection target. The acquisition date and time 505 stores the date and time that have acquired (an access is made to) contents therein. Furthermore, the acquisition result 506 stores the acquisition result of contents therein. For example, these are stored in the acquisition result 506: ‘successful’ when contents have been acquired successfully, ‘acquisition failed’ when contents have not been able to be acquired, ‘no change’ when the same contents as the contents previously acquired have been acquired, ‘unauthorized signature’ when an electronic signature, which will be described later, is unauthorized, and ‘updated signature’ when an electronic signature is updated. Moreover, the acquired content 507 records data of the acquired contents therein. Here, when the acquisition result 506 is ‘acquisition failed’ or ‘no change’, the acquired content 507 remains spaced (‘blank’).

Next, a flow of an inspection process (S308 in FIG. 3) done by the inspection processing module 32 of the inspection device 3 will be described.

The inspection processing module 32 performs the inspection process for multiple items of inspection target data recorded in the inspection target information 371 at every announcement number 401 (as inspection target data having the same announcement number 401 is a processing unit). Here, the inspection process is repeatedly performed for an appropriate fixed time intervals until the announcement expiration due 406 of the announcement contents with ‘yes’ for the announcement flag 405. Furthermore, the inspection processing module 32 uses the date and time provided by the timer module 33 to determine whether the announcement expiration due 406 has elapsed, and then finishes the inspection process. Moreover, for the time interval for performing the inspection process, it can be considered that the input receiving module 11 of the information registration terminal 1 receives a time interval inputted from the input control unit 904 at every announcement number 401 and the inspection requesting module 13 sends it to the inspection device 3 as inspection request information. Besides, it can be considered to use a predetermined interval (for example, once an hour, once a day). In addition, it is acceptable that the inspection processing module 32 refers to the downtime 407 in the inspection target information 371 and sets a time interval shorter than the downtime 407 at every announcement number 401. For example, the inspection process can be repeated at every 20 hours when the downtime 407 is 24 hours.

FIG. 6 shows a process flow of the inspection process. The inspection processing module 32 reads all the inspection target data having given announcement numbers 401 out of the inspection target information 371 at given time intervals (S601). Then, the inspection processing module 32 specifies the inspection target data for acquiring the contents (S602). More specifically, the inspection processing module 32 refers to the referrer 404 of each inspection target data read out, and acquires the contents of the inspection target data based on the order of the referrers 404. More specifically, it specifies the inspection target data that the address number of the inspection target data having undergone the inspection process just before is recorded in the referrer 404. Furthermore, when the address number of the inspection target data having undergone the inspection process just before is recorded in multiple referrers 404, it specifies inspection target data in a given order such as ascending address numbers. Furthermore, when the inspection process is first performed, the inspection processing module 32 specifies the inspection target data having ‘S’ stored in the referrer 404.

Subsequently, the inspection processing module 32 requests the information disclosure server 2 for contents as the address information 403 of the specified inspection target data is the destination (S603). More specifically, the inspection processing module 32 uses the communication processing module 36 to send a content request message through the network 5. This request message is sent by HTTP (Hyper Text Transfer Protocol), for example.

Moreover, the information disclosure server 2 sometimes receives only the request message having Referrer information (referrer information which a URL is referred to make access to the pertinent contents) added in a Referrer field of an http header in order to secure security, and rejects a request message added with no Referrer information. Therefore, the inspection processing module 32 refers to the address number 402 stored in the referrer 404 of the pertinent inspection target data when it sends a content request message, and reads out the address information 403 of the pertinent address number 402. Then, the inspection processing module 32 desirably sends the content request message where the address information read out is set to the Referrer field as Referrer information to the information disclosure server 2.

The address information 404 (Referrer information) specified from the referrer 404 is included in the content request message, and thus the inspection processing module 32 can send a message to the information disclosure server 2, which is the same message as the messages when requesting contents for inspection and when requesting contents through the Web browser from the user terminal 4. Accordingly, a deliberate unauthorized electronic announcement in which the information providing module 22 of the information disclosure server 2 distinguishes the content request message from the inspection device 3 and the content request message from the user terminal 4 based on whether the Referrer information exists or not is prevented. For example, unauthorized processing can be prevented such as processing in which the information providing module 22 deliberately provides authorized announcement contents only to the inspection device 3 and provides unauthorized announcement contents to the user terminal 4 different from the authorized announcement contents sent to the inspection device 3. Besides, it is desirable that the content request message from the inspection device 3 and the content request message from the user terminal 4 having the Web browser function are the same message in fields other than the Referrer field.

Subsequently, the inspection processing module 32 determines whether the requested contents were acquired from the information disclosure server 2 (S604). When the contents were acquired (YES at S604), the inspection processing module 32 determines whether the electronic signature of the acquired contents is authorized (S605). This is because a company making electronic announcement may assign an electronic signature to announcement contents in order to assure validity of the announcement contents. Here, the electronic signature (digital signature) is signature information that is encrypted for assuring the validity of digital document (contents).

More specifically, public key cryptography is used to assure that the creator of digital document (contents) and the document are not falsified. The registration requesting module 12 of the information registration terminal 1, which is a signee, uses its secret key to encrypt the announcement contents being digital document and creates a signature. It adds the created signature to the pertinent announcement contents and sends it to the information disclosure server 2. Subsequently, the information providing module 22 of the information disclosure server 2 sends the announcement contents added with the signature to the inspection device 3. Then, the inspection processing module 32 of the inspection device 3, which is a recipient, uses the signee's public key to decode the signature added to the pertinent announcement contents, and compares the decoded result with the pertinent announcement contents to verify whether the contents are correct. The use of an electronic signature can assure that the announcement contents provided by the information disclosure server 2 are not falsified and the signee is the creator of the announcement contents. Here, when the acquired contents do not have an electronic signature (for example, in case of referrer contents), the process at S605 is skipped to proceed to the next process (S606).

When the electronic signature is correct (YES at S605), the inspection processing module 32 determines whether the acquired contents are the same as the contents previously acquired (S606). More specifically, the inspection processing module 32 refers to the announcement archive 372 with the announcement number 501 and the address number 502 of the pertinent contents, and compares the contents acquired by this process with the latest acquired content 507 stored in the announcement archive 372. For example, the inspection processing module 32 directly compares each of byte sequence of the target contents for comparison, and thus determines whether the acquired contents are the same as the contents previously acquired. Furthermore, the latest acquired content 507 to be the target for comparison is the newest acquired content 507 that the acquisition result 506 is ‘successful’ and the acquisition date 505 is the newest.

Moreover, when the contents are different from the contents previously acquired (NO at S606), the case is included that the inspection processing module 32 has acquired the pertinent contents for the first time. More specifically, the inspection processing module 32 refers to the announcement archive 372, and determines that the contents are different from the contents previously acquired when the acquired content 507 having the announcement number 501 and the address number 502 of the pertinent contents is not registered in the case of new contents).

Then, when the acquired contents are the same as the contents previously acquired (YES at S606), the inspection processing module 32 adds the content acquisition information 508 to the announcement archive 372 for the contents of ‘no change’ (S607). More specifically, the inspection processing module 32 adds the content acquisition information 508 having the announcement number 501 and the address number 502 of the pertinent contents, the date and time that have acquired the contents to the acquisition date and time 505, and ‘no change’ to the acquisition result 506. In addition, since the acquired content 507 is not changed from the acquired content 507 previously acquired, the acquired contents are not stored in the acquired content 507, and remains spaced (blank).

On the other hand, when the acquired contents are different from the contents previously acquired (NO at S606), the inspection processing module 32 determines whether the pertinent acquired contents have new links (S608). The link is location information such as the other contents, document, and images embedded in the contents. For example, when the contents are HTML document, the inspection processing module 32 uses a processing program of the Web browser to analyze whether there is location information (for example, URL) of the other HTML document embedded in a given location of the HTML document. In addition, even in the case of the contents in other formats except HTML document, links can be set as similar to HTML document. In this case, the inspection processing module 32 uses a processing program for other formats to determine whether there is a link.

When the acquired contents have a new link (YES at S608), the inspection processing module 32 adds the contents of the destination link to the inspection target information 371 (S609). More specifically, the inspection processing module 32 adds the inspection target data to the inspection target information 371 in which the announcement number 401 now being processed is set to the announcement number 401, the address number 402 other than the existing address number 402 is set to the address number 402, and the detected link (URL) is set to the address information 403. Furthermore, when the detected link (URL) is already registered in the address information 403 about inspection target data of the announcement number 401 now being processed, the inspection processing module 32 does not add the contents of the destination link.

After the destination link is added to the inspection target information 371 (S609), or when there is no new link (NO at S608), the inspection processing module 32 determines whether the acquired contents are new (S610). More specifically, the inspection processing module 32 refers to the announcement archive 372 and determines that the contents are new contents, when the acquired content 507 is not registered in the announcement number 501 and the address number 502 of the pertinent contents, or when the announcement number 501 and the address number 502 of the pertinent contents are not registered in the announcement archive 372.

When the contents are new (YES at S610), the inspection processing module 32 registers the acquired contents in the announcement archive 372 (S611). More specifically, the inspection processing module 32 adds the announcement number 501 and the address number 502 of the target for processing to the announcement archive 372, and registers the content acquisition information 508 in which the date and time that have acquired the contents are set to the acquisition date and time 505, ‘successful’ is set to the acquisition result 506, and the acquired contents are set to the acquired content 507. Moreover, when the announcement number 501 and the address number 502 of the target for processing are already registered in the announcement archive 372, only the content acquisition information 508 is added.

In addition, in the cases where the contents cannot be acquired (NO at S604), where the electronic signature is unauthorized (NO at S605), and where the acquired contents are different from the contents previously acquired (NO at S610), the alert sending module 34 uses the communication processing module 36 to send an alert (the generation of abnormality and data of abnormality) to the information registration terminal 1 through the network 5 (S612). For example, the alert includes: an event that contents have failed to be acquired and the address information 403 of the target for processing or the electronic signature is unauthorized, an event that the acquired contents or the contents have been changed and the address information 403 of the target for processing.

Furthermore, the alert sending module 34 does not necessarily send an alert when the contents of the target for processing are not the announcement contents (in the case of the referrer contents). The inspection device 3 should certify that the announcement contents have been continuously disclosed during the announcement period and the announcement contents are not changed. However, the inspection device 3 does not need to certify the referrer contents other than the announcement contents because there is no problem even if information irrelevant to announcement is rewritten. Here, whether the contents of the target for processing are the announcement contents is determined by referring to the inspection target information 371 to tell whether the announcement flag 405 is ‘Yes’ or ‘spaced (blank)’.

An alert is sent to the information registration terminal 1, and thus a company making electronic announcement detects that abnormality has been generated in the information disclosure server 2. More specifically, the company making electronic announcement sometimes performs operations such as the division of shares after the announcement period is finished. In this case, when the announcement contents cannot be acquired for a long time, the company's management is sometimes hindered because it is not considered that the electronic announcement has been made validly. The inspection device 3 sends an alert to the information registration terminal 1, and thus the company making electronic announcement is allowed to detect failure and implement failure recovery tasks promptly.

After an alert is sent (S612), the inspection processing module 32 registers the content acquisition information 508 in the announcement archive 372 (S613). More specifically, when the contents have not been able to be acquired (NO at S604), the inspection processing module 32 adds the content acquisition information 508 to the announcement archive 372 in which the date and time that have acquired the contents are set to the acquisition date and time 505, ‘acquisition failed’ is set to the acquisition result 506, and the acquired content 507 is spaced (blank). Furthermore, when the electronic signature is unauthorized (NO at S605), the inspection processing module 32 adds the content acquisition information 508 to the announcement archive 372 in which the date and time that have acquired the contents are set to the acquisition date and time 505, ‘unauthorized signature’ is set to the acquisition result 506, and the acquired contents are set to the acquired content 507. Moreover, when the acquired contents are changed (NO at S610), the inspection processing module 32 adds the content acquisition information 508 to the announcement archive 372 in which the date and time that have acquired the contents are set to the acquisition date and time 505, ‘successful’ is set to the acquisition result 506, and the acquired contents are set to the acquired content 507.

Then, the inspection processing module 32 refers to the inspection target information 371, and determines whether there is subsequent inspection target data to be processed in the announcement number 401 of the target for processing (S614). More specifically, the inspection processing module 32 refers to the referrer 404 in the inspection target information 371, and determines whether there is inspection target data that the address number of the target for processing is the referrer. For example, in the case of data with ‘2501’ for the announcement number 401 and ‘1’ for the address number shown in FIG. 4, inspection target data with ‘S, 1’ for the referrer 404 (‘2’ for the address number 402) is the subsequent inspection target data. In addition, in the case of data with ‘4’ for the address number 402 now being processed, it does not have the subsequent inspection target data because there is no referrer 404 with ‘4’.

Subsequently, when there is the subsequent inspection target data (YES at S614), the inspection processing module 32 returns to S601 and again performs the inspection process for the subsequent inspection target data. Besides, when there is no subsequent inspection target data (NO at S614), the inspection processing module 32 ends the inspection process for the pertinent announcement number 401.

Next, the process after the announcement period is finished will be described.

The inspection processing module 32 compares the announcement expiration due 406 of the inspection target information 371 with the current date and time provided by the timer module 33 at every announcement number 401, and ends the inspection process after the announcement expiration due 406 has elapsed from the current date. Subsequently, when the inspection process is ended, the certificate issuing module 35 creates the certificate for the electronic announcement of the pertinent announcement number 401, and sends it to the information registration terminal 1 (see S314 in FIG. 3). The certificate for the electronic announcement certifies the disclosure conditions of the announcement contents disclosed on the information disclosure server 2, in which the content acquisition information 508 stored in the announcement archive 372 is described. Hence, the acquisition date and time 505, the acquisition result 506, and the acquired content 507 of the announcement contents is described in the certificate, and thus it can be certified as to when the electronic announcement has been disclosed. Furthermore, it is acceptable that the summarized contents are described in the certificate, not all the content acquisition information 508 of the announcement archive 372. Moreover, it is fine that not only the announcement contents but also the content acquisition information 508 of the referrer contents are described.

In addition, it is acceptable that suspension information about announcement contents during the announcement period is added to the certificate. The suspension information of announcement contents is information indicating that the announcement contents have not been able to be acquired or the electronic signature has been unauthorized from the beginning of announcement to the end of announcement. The certificate issuing module 35 reads out the announcement archive 372, and refers to the acquisition result 506. Then, the certificate issuing module 35 determines that the announcement contents have not been suspended when the acquisition result 506 is ‘successful’ and all the acquisition results 506 are ‘no change’ after that. In this case, the certificate issuing module 35 describes ‘no suspension of announcement’ in the certificate.

Furthermore, when ‘acquisition failed’ or ‘unauthorized signature’ is in the acquisition result 506, the certificate issuing module 35 calculates the period of time for the pertinent ‘acquisition failed’ or ‘unauthorized signature’. For example, the certificate issuing module 35 specifies the acquisition date and time 505 recorded with ‘successful’ or ‘no change’ before ‘acquisition failed’ or ‘unauthorized signature’ appeared in the acquisition result 506. Moreover, the certificate issuing module 35 specifies the acquisition date and time 505 recorded with ‘successful’ or ‘no change’ after ‘acquisition failed’ or ‘unauthorized signature’ appeared in the acquisition result 506. Subsequently, the certificate issuing module 35 calculates the period of time between the specified acquisition dates and times, and determines that the calculated period of time is suspension time. In addition, when a plurality of ‘acquisition failed’ or ‘unauthorized signature’ is recorded in the acquisition result 506 with ‘successful’ or ‘no change’ therebetween, the suspension time for each ‘acquisition failed’ or ‘unauthorized signature’ is calculated, and the total of the suspension time is given as the suspension time for the pertinent announcement contents. Subsequently, the certificate issuing module 35 describes the suspension time (including the total time for suspension time) in the certificate as it is a period of time that the announcement contents have not possibly been disclosed. Furthermore, when the suspension time exceeds the downtime 407 in the inspection target information 371, the certificate issuing module 35 adds that to the certificate. Moreover, when the suspension time exceeds the downtime 407, the electronic announcement of the pertinent announcement contents is not considered to have been made validly.

In addition, the data of the acquired contents is changed during the announcement period (NO at S610 in FIG. 6), it is acceptable that the disclosure periods of the contents before and after the change are respectively calculated and described in the certificate. For the disclosure periods of the contents before and after the change, the acquisition result 508 in the announcement archive 372 is referred. When the contents different from the previous contents are described in the acquired content 507 (that is, ‘successful’ is stored after ‘successful’), the disclosure period of the contents before the change and the disclosure period of the contents after the change are set as the acquisition date and time 505 for the latter ‘successful’ is boundary (the date and time when changed). At this time, the entry of the certificate includes the disclosure period (until the date and time when changed) and the contents before the change as information before the change. In addition, it also includes the disclosure period (after the date and time of the change) and the contents after the change as information after the change.

Furthermore, it is acceptable that the certificate issuing module 35 assigns an electronic signature to allow confirmation of validity of the contents when sending the certificate to the information registration terminal 1. Moreover, the certificate issuing module 35 sends the certificate for the information registration terminal 1 as well as stores the certificate in the storage module 37.

By performing the inspection process aforementioned, it is possible to certify that the contents of announcement disclosed by the information server 2 was validly electronically published during the period of announcement by inspecting the announcement contents disclosed on the information server 2 and by issuing certificate.

Next, four additional functions of the embodiment will be described. Here, the additional functions described below are not essential in the embodiment, but are the functions to enhance convenience and accuracy of the inspection process.

First, an inspection process for dynamic contents, which is a first additional function, will be described. The dynamic contents are that the information disclosure server 2 dynamically creates contents in accordance with the contents inputted from the user terminal 4. More specifically, the user terminal 4 receives information (a parameter and its value) inputted from the input control unit 904, and sends the information to the information disclosure server 2. Then, the information disclosure server 2 dynamically creates contents to be sent to the user terminal 4 based on the information having been sent.

When the input form is the HTML format, information inputted to an input space of the input form is included in a content request message from the user terminal 4 to the information disclosure server 2 as a set of the parameter 408 and the value 409 (see FIG. 4). At this time, when a content request message created by the Web browser is based on the HTTP GET' method, the parameter 408 and the value 409 thereof can be directly described in the address information 403 (URL) of the pertinent contents. However, when the parameter 408 and the value 409 thereof are directly described in the address information 403 (URL), the address information 403 itself is shared but the parameter 408 and the value 409 are different, and thus a plurality of inspection target data (that is, the address information 403) is created by the number that the value 409 can take as much as possible. Furthermore, when the content request message uses the HTTP ‘POST’ method, it is likely to become difficult to specify the address information 403 beforehand. This is because the parameter and the value cannot be described in the address information 403 since the parameter and the value sent from the Web browser are described in data main body in the ‘POST’ method.

The items of the parameter 408 and the value 409 are provided in the inspection target information 371, and thus the inspection process for dynamic contents can be performed efficiently with no increase in the number of inspection target data (the address information 403).

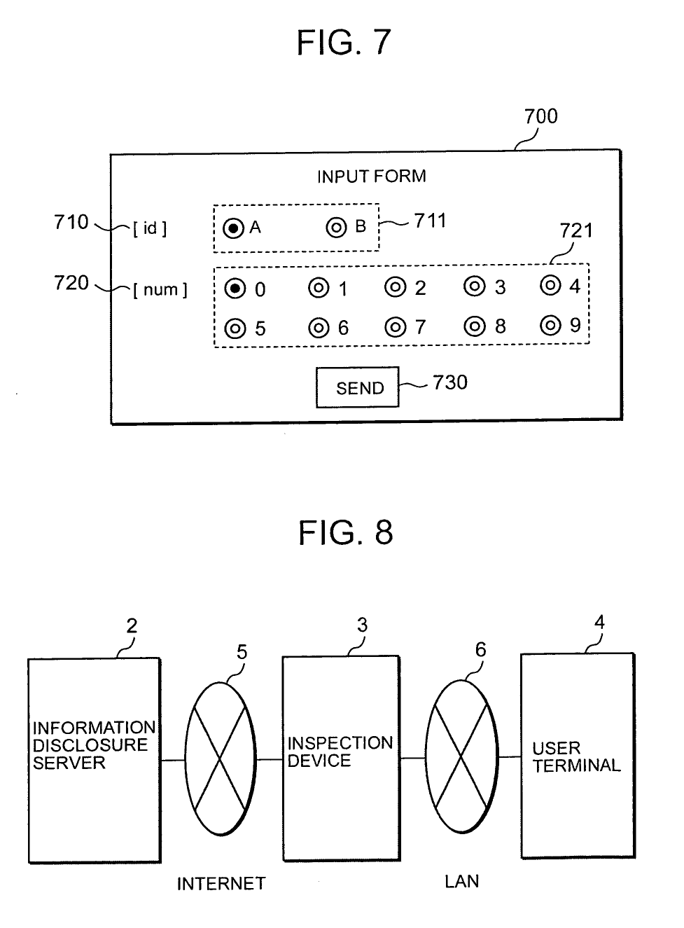

FIG. 7 shows an exemplary input form 700 displayed on the output control unit 905 of the user terminal 4. FIG. 7 shows an input form 700 in which the announcement number 401 is ‘3001’ and the address number 402 is ‘2’ in the inspection target information 371 shown in FIG. 4. In the input form 700, ‘id’ 710 and ‘num’ 720 are displayed as the parameters 408. Furthermore, in the input form 700, ‘A’ and ‘B’ 711 are displayed by radio buttons as the value 409 of the ‘id’ 710. Moreover, symbol ‘I’ in ‘A|B’ described in the inspection target information 371 indicates that one of the two values is selected. Therefore, in the form 700, designation on the value ‘A’ or ‘B’ can be received by the radio buttons.

In addition, in the input form 700, values 721 are displayed from ‘0’ to ‘9’ by radio buttons as the values 409 for ‘num’ 720. Besides, symbol ‘-’ in ‘0-9’ described in the inspection target information 371 indicates that any one of integers from 0 to 9 is designated, that is, it indicates the range of the possible values. Therefore, the form 700 can receive designation of any one of values from ‘0’ to ‘9’ by the radio buttons. Furthermore, the input form 700 has a send button 730. When the send button 730 is pressed down, a content request message is sent to the information disclosure server 2.

Moreover, the description method for the value 409 in the inspection target information 371 can make definition by using various symbols other than ‘|’ and ‘-’. In addition, for the values 711 and 721 in the input form, any one of the values is selected by the radio buttons. However, it is acceptable that multiple values are selected by using checkboxes. Moreover, the parameter 408 and the value 409 are included in inspection request information sent by the information registration terminal 1 to the inspection device 3.

In this manner, when the parameter 408 and the value 409 are recorded in the inspection target information 371, the inspection processing module 32 sends a content acquisition request message including the parameter 408 and the value 409 to the information disclosure server 2. For example, in the case of the HTTP ‘GET’ method, the parameter 408 and the value 409 are described at the beginning of the data of the content acquisition request (HTTP Request), following the address information 403 after the ‘GET’ (method). Furthermore, in the case of the HTTP ‘POST’ method, the parameter 408 and the value 409 are described in the data main body of the content acquisition request (the part following the method for the http request and header information (http additional information)).

Moreover, when there is a single set of the parameter 408 and the value 409, the inspection processing module 32 specifies the parameter 408 and the possible value 409 individually to request contents. For example, when there is a single set that the parameter 408 is ‘id’ and the value 409 is ‘A|B’, the inspection processing module 32 makes a content request where ‘A’ is designated to the value 409 and a content request where ‘B’ is designated to the value 409. In addition, when there are multiple sets of the parameter 408 and the value 409, the inspection processing module 32 requests contents by separately changing the individual values 409 (that is, all the combined patterns). For example, when the value 409 is ‘A|B’ for the parameter 408 with ‘id’ and the value 409 is ‘0-9’ for the parameter 408 with ‘num’, the pattern of the possible value is 20 patterns: a product of two ‘id’ patterns and ten ‘num’ patterns. Besides, when the parameter 408 and the value 409 are used to make a content acquisition request, the inspection processing module 32 stores the content acquisition information 508 in the announcement archive 372 at each of the parameter 408 and the value 409 specified.

Next, a method for creating the inspection target information 371, which is a second additional function, will be described.

As described above, for the inspection target information 371, the inspection receiving module 31 receives inspection request information sent by the information registration terminal 1 to the inspection device 3, and stores it in the inspection target information 371. However, even though inspection target data for announcement contents is registered in the inspection target information 371, a user sometimes cannot make access to announcement contents when the user uses the Web browser from the user terminal 4 to make access thereto. For example, an access sometimes cannot be made to announcement contents because links are not properly set to the referrer contents by intention or by negligence. Moreover, even though links are properly set to the referrer contents, a user sometimes cannot recognize that the links are set when displayed on the output control unit 905 of the user terminal 4.

An access is made to the announcement contents through links to the referrer contents such as homepages of companies making electronic announcement and Web pages separately prepared for electronic announcement, or Websites prepared by third parties such as official organizations (Websites linked to the announcement contents of multiple companies) However, links are not always properly set until the announcement contents are reached from such referrer contents.

In addition, when the information disclosure server 2 can distinguish between a content request from the inspection device 3 and a content request from the user terminal 4, it is possible for the information disclosure server 2 to send different contents by the request from the inspection device 3 and by the request from the user terminal 4. For example, different contents are likely to be sent when a company making the electronic announcement is to deliberately make unauthorized electronic announcement.

In order to prevent such unauthorized electronic announcement, the inspection processing module 32 of the inspection device 3 acquires operation information of the user terminal 4 when acquiring announcement contents, and registers it in the inspection target information 371.

FIG. 8 shows a schematic diagram illustrating a announcement inspection system which implements the second additional function. As shown in the drawing, a user terminal 4 is connected to an inspection device 3 through an internal network 6 such as a LAN. In addition, the inspection device 3 and an information disclosure server 2 are connected to each other through a network 5 such as the Internet as similar to FIG. 1. The inspection device 3 functions as a proxy server for the user terminal 4. The proxy server is a server that connects to the Internet instead of computers in the internal network that cannot be directly connected to the Internet. When the user terminal 4 sends request to the information disclosure server 2 by the Web function, the request is sent through the inspection device 3. Then, the inspection device 3 acquires operation information of the user terminal 4, and stores it in inspection target information 371.

The user terminal 4 uses the Web browser to request contents and displays the requested contents on an output control unit 905, as similar to the case of being directly connected to the information disclosure server 2, not through the inspection device 3. The user terminal 4 first makes access to a homepage of a company making electronic announcement when requesting contents, for example, and follows links of that homepage to acquire the intended announcement contents.

An inspection processing module 32 of the inspection device 3 passes on sequential content request messages from the user terminal 4, and sends them to the information disclosure server 2. Subsequently, the inspection processing module 32 receives the requested contents from the information disclosure server 2, and sends the received contents to the user terminal 4. Then, the inspection processing module 32 stores the data of the sequential content request messages in the inspection target information 371. Hereinafter, a method for storing data in the inspection target information 371 by the inspection processing module 32 will be described.

First, the inspection processing module 32 receives a content request message to the information disclosure server 2 from the Web browser of the user terminal 4. Then, the inspection processing module 32 registers the request message received from the user terminal 4 in the inspection target information 371. When the request message is first received, the inspection processing module 32 acquires a new announcement number 401 different from the announcement number 401 already registered in the inspection target information 371, and sets it to the announcement number 401. Subsequently, the inspection processing module 32 sets ‘1’ to the address number 402, a URL (for example, information about the ‘GET’ method in the header part in the HTTP request) included in the request message to the address information 403, ‘S’ to the referrer 404, and ‘0’ to the reference interval 410.

In addition, when a request message is received after the second time, the inspection processing module 32 sets the same announcement number 401 as that at the first time to the announcement number 401, the value that ‘1’ is added to the value of the address number 402 registered in the inspection target information 371 just before to the address number 402, a URL included in the request message from the user terminal 4 to the address information 403, the referrer information (for example, Referer information in the HTTP header part) included in the request message to the referrer 404, and registers them in the inspection target information 371. Furthermore, the elapsed time from the acquisition time of the first request message from the inspection processing module 32 to the acquisition time of this request message is set to the reference interval 410. Moreover, a timer module 33 is used to acquire each time. Further, it is acceptable that the elapsed time from the acquisition time of the previous request message to the acquisition time of this request message is set to the reference interval 410.

Besides, when the parameter 408 and the value 409 are included in the received contents, the inspection processing module 32 sets each item of information to the parameter 408 and the value 409 in the inspection target information 371. More specifically, the inspection processing module 32 detects and sets items included in the form of the received contents (for example, checkboxes, select components, input components in HTML form components) and the possible values. The possible values are ‘on’ and ‘blank (space)’ in the case of the checkbox, and the data of option components included there below in the case of the select component, for example. Further, an inspection receiving module 31 sets the announcement flag 405, the announcement expiration due 406, the downtime 407, and the backup number 411 to the inspection target information 371 based on inspection request information sent by the information registration terminal 1 to the inspection device 3.

After acquiring operation information of the user terminal 4 to create inspection target data in the inspection target information 371, the inspection processing module 32 performs the inspection process described above (see FIG. 6). At that time, the inspection processing module 32 requests contents by order based on the referrer 404 in the inspection target information 371 (that is, in ascending order of the address number 402). Furthermore, the inspection processing module 32 refers to the reference interval 410 in the inspection target information 371, and sequentially sends content request messages to the information disclosure server 2 at instructed time intervals.

By creating the inspection target information 371 with acquiring operation information of the user terminal 4, it is possible to prevent the company making electronic announcement deliberately or by negligence set inappropriate links on the referrer contents to make access to the announcement contents difficult. Moreover, it is also prevented for the information disclosure server 2 to detect the content request message sent from the inspection device in order to provide the announcement contents different from the announcement contents provided to the user terminal 4. For example, a unauthorized act can be avoided in which attempt to obtain certificate of authorized electronic announcement when announcement contents impossible to be referred to by the user terminal 4 is solely sent to inspection device 3.

Next, a process for modifying (changing) the electronic signature, which is a third additional function, will be described.

For the electronic signature, an electronic certificate (electronic data) is used which certifies that a disclosed public key is paired with a secret key of a company making electronic announcement. This electronic certificate is defined with a usable period (for example, one year). The announcement contents having the electronic signature assigned sometimes have the case where the period of the electronic certificate for the pertinent electronic signature is expired and invalid during the announcement period. When the electronic certificate becomes invalid, it cannot be confirmed by the electronic signature whether the announcement contents is correct data. Thus, the input receiving module 11 of the information registration terminal 1 receives the contents having a new electronic signature for the electronic certificate assigned that is inputted from the input control unit 904 before the electronic certificate is expired. Then, the registration requesting module 12 sends the contents having the new electronic signature assigned to the information disclosure server 2. Subsequently, the registration receiving module 21 of the information disclosure server 2 receives the contents with the electronic signature, and registers them in the storage module 23. After that, the information providing module 22 sends the contents with the new electronic signature in accordance with a request from the user terminal 4 or the inspection device 3.

In this case, when determining whether the acquired contents are the same as the contents previously acquired (S606 in FIG. 6), the inspection processing module 32 of the inspection device 3 sets ‘updated signature’ to the acquisition result 506 and the contents having the new electronic signature assigned to the acquired content 507 in the announcement archive 372 for registration, when only the electronic signature is changed and no change is observed in the other parts (the main body of the announcement contents) More specifically, the inspection processing module 32 separates the contents previously acquired and the acquired contents acquired this time into a announcement content main body and an electronic signature part thereto. The electronic signature part is data relating to the electronic signature included in the contents such as cipher data (data encrypted by a secret key), data of date and time, the electronic certificate (data including a public key for verifying the electronic signature), and data specifying the electronic certificate. The inspection processing module 32 compares the previous announcement content main body with the announcement content main body this time to confirm that there is no change, and also compares the electronic signature parts. It determines that only the electronic signature is modified when a change is observed in the electronic signature parts.

In addition, when adding suspended information to the certificate, the certificate issuing module 35 handles the same as the case of ‘no change’ when the acquisition result 506 is ‘updated signature’, and considers that the same announcement contents as the announcement contents previously acquired are being continuously disclosed.

Accordingly, it can be determined that the announcement contents are being continuously disclosed on the information disclosure server 2 when the announcement contents themselves are not changed, even though the valid period of the electronic certificate is expired during the announcement period and the announcement contents has the new electronic signature added.

Next, a process when the backup server exists in the information disclosure server 2, which is a fourth additional function, will be described.

The announcement contents need to be continuously disclosed on the information disclosure server 2 during the announcement period, but such conditions are sometimes generated that the announcement contents cannot be acquired because of failure of the information disclosure server 2. For example, there are failure of hardware or software in the information disclosure server 2, failure of networks, and operational errors by the administrator of the information disclosure server 2. Therefore, in order to improve the reliability of the information disclosure server 2, it is desirable that a backup server for the information disclosure server 2 is prepared beforehand and the announcement contents are continuously disclosed on the backup server even though abnormality is generated in the information disclosure server 2. More specifically, the same data of the announcement contents as that in the information disclosure server 2 is registered in the backup server, and the user terminal 4 acquires the announcement contents from the backup server when failure is generated in the information disclosure server 2.

Hereinafter, an inspection process when there is the backup server will be described. Here, the backup server is considered to have the same function and the same hardware configuration as that of the information disclosure server 2. Besides, a single or multiple backup servers are acceptable.

The registration requesting module 12 of the information registration terminal 1 sends announcement information received by the input receiving module 11 to the backup server. Hence, this process is the same as the registration request for the information disclosure server 2 (S302 in FIG. 3). Then, an information providing module 22 of the backup server discloses the announcement contents sent from the information registration terminal 1. Moreover, the inspection request module 13 of the information registration terminal 1 sends inspection request information added with information about the backup server to the inspection device 3. Subsequently, the inspection receiving module 31 of the inspection device 3 registers inspection target data in the inspection target information 371 based on the inspection request information sent by the information registration terminal 1.

The backup number 411 is set to backup inspection target data disclosed on the backup server. The address number 402 of inspection target data to be backed up is stored in the backup number 411. Then, the same contents are provided to the backup inspection target data and inspection target data set to the backup number 411 for the pertinent backup inspection target data. Furthermore, when it is not backup inspection target data (that is, inspection target data disclosed on the information disclosure server), the backup number 411 is blank (spaced). In the example of the inspection target information 371 shown in FIG. 4, inspection target data with ‘4500’ for the announcement number 401 and ‘6’ for the address number is backup inspection target data with ‘2’ for the address number 402.

The inspection process for inspection target data having the backup server is performed by any one of the following methods. A first method is in which when the inspection processing module 32 of the inspection device 3 has not been able to acquire contents (see NO at S604 in FIG. 6), it refers to the inspection target information 371, and instead acquires the contents of inspection target data that specify the address number 402 of the pertinent inspection target data to the backup number 411. Then, when the inspection processing module 32 has been able to acquire the contents of backup inspection target data, it determines that the contents have been acquired successfully (YES at S604), and proceeds to S605. On the other hand, when the inspection processing module 32 has not been able to acquire the contents of backup inspection target data, it determines that the contents have failed to be acquired (NO at S604), and proceeds to S612. Moreover, when there is a plurality of backup inspection target data, it sequentially acquires the contents of backup inspection target data until it successfully acquires the contents.

In the first method, when the contents have been acquired successfully either in inspection target data of the information disclosure server 2 or inspection target data of the backup server, it is determined that the contents have been able to be acquired (YES at S604). Therefore, the number of times that the inspection processing module 32 acquires contents can be made minimum.

In a second method, the inspection processing module 32 of the inspection device 3 acquires all the contents of backup inspection target data, regardless of whether it has been able to acquire the contents (S604). Then, even through ‘acquisition failed’ is recorded in the acquisition result 506 in the announcement archive 372 when the certificate issuing module 35 creates a certificate, it is determined that the pertinent contents have been continuously disclosed when ‘successful’ or ‘no change’ is stored in the acquisition result 506 of the backup inspection target data.

In addition, it is acceptable that the inspection processing module 32 compares the contents acquired from the information disclosure server 2 with the contents acquired from the backup server and notifies the alert sending module 34 when the compared results are different. Subsequently, the alert sending module 34 sends an alert indicating that the contents acquired from the information disclosure server 2 is different from the contents acquired from the backup server to the information registration terminal 1. Then, the inspection processing module 32 also stores the content acquisition information 508 in the announcement archive 372 regarding to the backup inspection target data. Also, it is acceptable that the content acquisition information 508 about the backup inspection target data stored in announcement archive 372 and the data of the alert are described in the certificate created by the certificate issuing module 35.

As described above, in the case where the announcement contents can be acquired from the backup server even when the announcement contents cannot be acquired from the information disclosure server 2, it can be determined that the announcement contents are being continuously disclosed. Furthermore, when the contents acquired from the information disclosure server 2 are different from the contents acquired from the backup server, an alert is sent to the information registration terminal 1, and thus a company making electronic announcement can be notified of abnormality.

As described above, one embodiment according to the present invention has been described.

According to the embodiment, it can be certified that the electronic announcement disclosed on networks are being continuously disclosed during the announcement. In addition, even when an event is generated that the announcement contents cannot be acquired during the announcement, it can be determined that the announcement contents have been continuously disclosed when the suspension time is shorter than a fixed allowed time (the downtime 407).

Furthermore, in the case of the announcement contents to which an access is made through the homepage of a company making electronic announcement or through links of the homepage of third parties such as official organizations, it can be inspected whether improper links are set through which ordinary users cannot make access to the announcement contents. Accordingly, a unauthorized act can be prevented in which the correct announcement contents are provided only to the inspection device 3 to obtain a certificate certifying that the electronic announcement has been made.

Moreover, when the announcement contents cannot be acquired, and when an electronic signature assigned to the announcement contents is unauthorized, sending an alert can notify a company making electronic announcement that abnormality has been generated.

Besides, when the announcement contents are disclosed on both the information disclosure server 2 and the backup server, it can be determined that the announcement contents are being continuously disclosed when any one of the servers can acquire the announcement contents.

In addition, the present invention is not limited to the embodiment, which can be modified variously within the scope of the teachings.

For example, in the above embodiment, the alert sending module 34 of the inspection device 3 immediately sends an alert to the information registration terminal 1 when the announcement contents have failed to be acquired (S612 in FIG. 6). However, it is acceptable that the alert sending module 34 stores the data of the alert in the storage module 37, and sends alert information stored in the storage module 37 to the information registration terminal 1 when the information registration terminal 1 requests the inspection device 3 for the alert information. Furthermore, it is fine that alert information is sent to the other terminals different from the information registration terminal 1. When it is sent to the other terminals different from the information registration terminal 1, for example, the inspection receiving module 31 receives the destination of alert information from the information registration terminal 1 at every announcement number 401 beforehand and stores it in the storage module 37.

Moreover, it is acceptable that alert information is sent by using electronic mail. For example, the inspection receiving module 31 receives the address of electronic mail from the information registration terminal 1 at every announcement number 401 beforehand, and stores it in the storage module 37. Then, the alert sending module 34 refers to the address of electronic mail for the pertinent announcement number 401 stored in the storage module 37 when sending the alert, and sends the data of the alert to the address of the referred electronic mail by electronic mail.

In addition, in the embodiment, the inspection processing module 32 of the inspection device 3 periodically performs the inspection process (see FIG. 6) at fixed time intervals. However, it is acceptable that the inspection processing module 32 performs inspection at time intervals randomly shifted from fixed time intervals. That is, the inspection processing module 32 schedules the next inspection process after having performed this inspection process, but for the scheduling, for example, it creates random numbers to determine the time shifted from fixed time intervals. Then, the inspection processing module 32 stores the time for the next process randomly shifted from fixed time intervals in the storage module 37, and uses the timer module 33 to perform the inspection process at that time. However, when the downtime 407 is set to the inspection target information 371, the time intervals randomly shifted from fixed time intervals are not set longer than the set time.

Furthermore, it is fine that the reference interval 410 set in the method which creates the inspection target information 371, the second additional function, is varied randomly in time intervals. However, the time range to be shifted randomly is not to exceed a given rate (for example, a half) of the reference interval 410 stored in the inspection target information 371. Moreover, the given rate is considered to be stored in the storage module 37 of the inspection device 3 beforehand.

When the inspection processing module 32 performs the inspection process at random time intervals, the information disclosure server 2 could be made difficult to distinguish between the content request message from the inspection device 3 and the content request message from the user terminal 4. Accordingly, unauthorized processing can be prevented in which the information disclosure server 2 deliberately varies the announcement contents provided to the inspection device 3 and the announcement contents provided to the user terminal 4.

1. An apparatus for inspecting announcement data disclosed through a network, comprising:
a storage module which stores inspection target information including address information and a announcement expiration due of announcement data, and acquired inspection information including an acquisition result and an acquisition date and time of each of the announcement data;
a receiving module which receives inspection target information of the announcement data from an external system, and stores the target information in the storage module;
an inspecting module which reads out the inspection target information stored in the storage module at predetermined time intervals assigned for each announcement data, requests announcement data through the network based on the inspection target information read out, and stores the acquired inspection information of the announcement data in the storage module at every request for announcement data;
an alert module which sends an alert message to the external system when announcement data requested by the inspecting module has failed to be acquired; and
an issuing module which refers to the announcement expiration due of the inspection target information stored in the storage module, reads from the storage module the acquired inspection information of the announcement data expired the announcement due, and creates a certificate including the acquisition result and the acquisition date and time at every request for the pertinent announcement data.

2. The apparatus according to claim 1,
wherein the inspecting module verifies an electronic signature assigned to acquired announcement data, and
the alert module sends an alert message to the external system when the electronic signature verified by the inspecting module is unauthorized.

3. The apparatus according to claim 1,
wherein the acquired inspection information further includes acquired announcement data, and
wherein when the inspecting module successfully acquires a requested announcement data, the inspecting module: reads out the acquired inspection information of the pertinent announcement data; compares the acquired announcement data with the announcement data of the inspection target information stored in the storage module; and stores the acquired announcement data in the inspection target information of the storage module, when the acquired announcement data and the announcement data of the inspection target information are different.

4. The apparatus according to claim 1,
wherein the inspection target information further comprises a downtime which is an allowed time for suspension of announcement data acquisition,
wherein a predetermined time interval for each of the announcement data is shorter than the downtime, and
the inspecting module requests announcement data through a network at timing randomly shifted from the predetermined time interval for each of the announcement data.

5. The apparatus according to claim 1,
wherein the inspection target information further comprises order information indicating order of acquiring announcement data,
wherein the inspecting module requests announcement data through a network based on order information included in the inspection target information.

6. The apparatus according to claim 1,
wherein the inspection target information further comprises a variable item of announcement data and information that can set to the pertinent variable item,
wherein the inspecting module sets each of information that can be set to the variable item and requests announcement data through a network.

7. The apparatus according to claim 1,
wherein the receiving module receives a request message that requests the announcement data from the external system through the network, and sets address information of the announcement data included in the request message to the inspection target information.

8. The apparatus according to claim 7,
wherein the request message further includes order information that indicates order of acquiring announcement data,
wherein the receiving module receives the request message from the external system, and sets order information included in the request message to the inspection target information, and
the inspecting module requests announcement data through a network based on the order information included in the inspection target information.

9. The apparatus according to claim 7,
wherein the receiving module sets received time at which the request message has been received from the external system to the inspection target information, and
the inspecting module requests announcement data through the network based on the received time in the inspection target information.

10. The apparatus according to claim 1,
wherein when the inspecting module acquires announcement data requested through the network, it determines whether address information of the other announcement data is included in the acquired announcement data, and
when address information of the other announcement data is included, it sets the pertinent other announcement data to the inspection target information.

11. The apparatus according to claim 2,
wherein the acquired inspection information further comprises acquired announcement data,
wherein when the inspecting module verifies an electronic signature assigned to the acquired announcement data and found that the electronic signature is authorized, the inspecting module:
reads out the acquired inspection information of the pertinent announcement data stored in the storage module; compares the acquired announcement data with announcement data of the acquired inspection information stored in the storage module; and determines that the acquired announcement data is the same as the announcement data stored in the storage module when only the electronic signature is different.

12. The apparatus according to claim 1,
wherein a plurality of address information for each of the announcement data is stored in the inspection target information,
the inspecting module requests announcement data through the network by specifying each of the address information, and
the alert module sends an alert message to the external system when all the requested announcement data has failed to be acquired.

13. The apparatus according to claim 1,
wherein a plurality of address information for each of the announcement data is stored in the inspection target information,
the inspecting module requests announcement data through the network by specifying each of the address information, and compares each of the pertinent requested announcement data acquired through the network, and
the alert module sends an alert message to the external system when each of the pertinent requested announcement data is different.

14. A computer readable program for inspecting announcement data disclosed through a network, comprising:
a storing step of storing inspection target information including address information and a announcement expiration due of announcement data and acquired inspection information including an acquisition result and an acquisition date and time of announcement data in a storage module;
a receiving step of receiving the inspection target information of the announcement data from an external system and storing the inspection target information in the storage module;
an inspection step of reading out the inspection target information stored in the storage module at predetermined time intervals assigned for each announcement data, requesting announcement data through the network based on the inspection target information read out, and storing the acquired inspection information of the pertinent requested announcement data in the storage module at every request for announcement data;
an alert step of sending an alert message to the external system when announcement data requested by the step of inspecting has failed to be acquired; and
an issuing step of referring to the announcement expiration due of the inspection target information stored in the storage module, reading from the storage module the acquired inspection information of the announcement data expired the announcement due, and creating a certificate including an acquisition result and an acquisition date and time at every request for the pertinent announcement data.

15. A method for inspecting announcement data disclosed through a network, comprising:
a receiving step of receiving inspection target information including address information and a announcement expiration due of announcement data from an external system and storing the inspection target information in a storage module;
an inspecting step of reading out the inspection target information stored in the storage module at predetermined time intervals, requesting announcement data through the network based on the inspection target information read out, and storing the acquired inspection information of the announcement data in the storage module at every request for announcement data;
an alert step of sending an alert message to the external system when announcement data requested at the inspection step has failed to be acquired,
an issuing step of referring to the announcement expiration due of the inspection target information stored in the storage module, reading from the storage module the acquired inspection information of the announcement data expired the announcement due, and creating a certificate including the acquisition result and the acquisition date and time at every request for the pertinent announcement data.
